(19) United States
(12) Patent Application Publication
(10) Pub. No.: US 2008/0167992 A1
(43) Pub. Date: Jul. 10, 2008

(54) Methods and systems for an accountable media advertising application

(75) Inventors: Michael Kokernak, Boston, MA (US); Gavin O'Donoghue, Huntington Station, NY (US)

Correspondence Address: ROPES & GRAY LLP, PATENT DOCKETING 39/41, ONE INTERNATIONAL PLACE, BOSTON, MA, 02110-2624, US

(73) Assignee: Backchannelmedia Inc., Boston, MA (US)

(21) Appl. No.: 11/650,007

(22) Filed: Jan. 5, 2007

(51) Int. Cl. G06Q 30/00; H04L 9/00

(52) U.S. Cl. 705/51; 705/26; 705/14; 705/10

(57) ABSTRACT

The systems and methods described herein relates to a system for allowing a consumer to track an advertisement for a product. The system includes an equipment for capturing a response by the consumer to the advertisement delivered from a first platform. The system also includes a portal, provided on a second platform, that permits the consumer to execute a purchase-related activity associated with the product of the advertisement. The system additionally includes an analysis application for generating a trigger that correlates data associated with the consumer response to data associated with the purchase-related activity. Furthermore, the system includes a server configured to display a plurality of triggers that allow the consumer to at least track the advertisement selected by the consumer from the first platform.

### FIELD OF THE INVENTION

The systems and methods described herein generally pertain to the field of media advertising. More particularly, these systems and methods pertain to an interactive application for creating an accountable advertising environment wherein data associated with advertisement content is regulated and utilized to drive actionable sales across multiple media platforms.

### BACKGROUND

Traditional approaches to purchasing TV advertisement are under close scrutiny due to a dramatic increase in the number of television channels across a variety of media platforms. This expansion in channel capacities are forcing advertisers to become more creative in blending advertising campaigns across multiple platforms. The complex nature of today's media campaigns makes it difficult to eliminate ineffectual spending on advertising. As such, with the adoption of interactive elements on television and blended media campaigns on the rise, there is a need to capture reactions of consumers to television programs and turn them into actionable sales across a variety of media platforms.

### SUMMARY

The systems and methods described herein include, among other things, a system that allows a consumer to bookmark or track an advertisement for a product delivered from a media platform, such as a television. In particular, a response by the consumer to the advertisement is captured by an equipment, for example, a set-top box, coupled to the consumer's television set. The equipment then forwards the consumer response to a portal, on which the consumer is able to execute a purchase-related activity associated with the product of the advertisement. The portal may be provided in the form of a website, herein referred to as a “web portal.” However, other platforms, such as a television, may be used to provide the portal to the consumer. An analysis application is additionally provided by the system to store and manage a trigger that correlates data associated with the consumer response to data associated with the purchase-related activity. Furthermore, the system includes a server configured to display multiple triggers from which the consumer is able to track the selected advertisement. In certain implementations, the server displays the multiple triggers from the same web portal on which the consumer executed the purchase-related activity.

In certain embodiments, the purchase-related activity may also be performed by the consumer from a website accessible from the web portal. Exemplary purchase-related activities include data retrieval, data review, data cataloging, data deletion, purchase execution, and media content download by the consumer via at least one of the web portal and the website.

In one embodiment, the website may be provided by a retailer sponsoring the advertisement or selected by the consumer for incorporation into the website. In certain instances, the consumer opts to receive, via the web portal, additional advertisements for a product similar to or same as the advertised product. The consumer is able to adjust, from the web portal, the frequency and type of the opt-in advertisements he or she receives. The consumer is also able to entirely opt out the advertisements. In certain instances, a retailer may offer a discount incentive, send a reminder, or present a targeted advertisement to the consumer, via at least one of the web portal, the website, the equipment, and a mailing address of the consumer.

In one embodiment, communication between the analysis application and at least one of the consumer, the retailer and a media provider is enabled via at least one of the equipment, the web portal and the merchant website. The media provider may be a cable company, a telephone company (TELCO), a Regional Bell Operating company (RBOC), a digital broadcast station, an over-builder, or a direct broadcast satellite company. This two-way communication assists the analysis application in capturing the consumer response data as well as the data associated with the purchase-related activity.

In one embodiment, the interactive environment includes a head-end processor in communication with the equipment, such as a set-top box, in order to receive the data associated with the consumer response and forward the data to the analysis application for advertisement accountability determination.

In one embodiment, the trigger is first embedded in the advertisement content delivered to the consumer. Upon the consumer responding to the advertisement, the trigger captures the data associated with the consumer response and is forwarded, via the analysis application, to the web portal or the merchant website for incorporation into a link. Subsequently, when the consumer executes a purchase order via an activation of the link, the trigger captures sales data generated from the executed purchase order. The purchase order may be executed based on the consumer downloading music, video or textual content from the web portal or the website. The resulting executed trigger, which includes both the consumer response data and the sales data, is transmitted to the analysis application for determining a measure of success of the advertisement. More specifically, the data related to the consumer response is adapted to reveal at least one of time of the consumer response, origin of the consumer response, and demographic information of the consumer. The sales data is adapted to reveal at least one of time, price point and location of the purchase order.

In one embodiment, the analysis application uses the trigger to track online content download by the consumer as well as bandwidth associated with the download. Consequently, the tracked information may be used by a provider of the website to provision bandwidth for future downloads as well as charge appropriate fees for the future downloads. In addition, a decision of the consumer opting into an advertisement through the web portal may be captured by the trigger and communicated to the analysis application for advertisement accountability analysis.

In one embodiment, the trigger is encrypted by the analysis application to conceal placement information of the advertisement which includes at least one of time of the consumer response, origin of the consumer response, and demographic information of the consumer. The encrypted trigger may be decrypted inside of the analysis application for allowing the advertisement placement information to be matched to the purchase-related data, wherefrom a measure of accountability of the advertisement is determined. Subsequently, the trigger is accessible by at least one of the media provider, the retailer, and an advertiser for refining a strategy associated with advertising in a media advertising space. Exemplary media advertising spaces include a television space, the Internet space, a billboard space, a publishing space, and a direct mailing space.

In one embodiment, the analysis application further includes an advertisement search engine that is adapted to provide one or more retailer websites based on a search term supplied to the search engine. The one or more websites are ranked according to information revealed by the triggers corresponding to purchase orders executed from the respective websites.

According to another aspect of the invention, a web-based application is provided to track performance of interactive advertisements. The application includes a first interface for receiving response data by a consumer based on the consumer responding to an advertisement in an interactive environment. The application also includes a second interface for communicating with a web portal that allows the consumer to perform a purchase-related activity associated with a product of the advertisement. In addition, the application includes a data library for storing a trigger that associates the consumer response data to data generated from the purchase-related activity, wherein the trigger provides a user of the application a degree of accountability for the advertisement. The user may be a cable company, a media outlet, a direct mail company, an advertiser, a billboard company, a publishing company, a catalog company, or a retailer.

In one embodiment, the trigger, stored in an opt-in portion of the data library, reveals an identity of the consumer when accessed by the user, and the access is permitted based on the consumer opting to receive, via at least one of the interactive environment, the web portal, and a mailing address of the consumer, advertisements for a product similar to or same as the advertised product.

In one embodiment, the first interface of the application is able to communicate with one or more consumers via multiple nodes, where each node is linked to at least a subset of the consumers, and the consumers tend to be non-identifiable to the user. In addition, the second interface is able to communicate to one or more users via multiple servers, where each server is linked to at least a subset of the users, and the users access the trigger according to permission levels assigned to respective ones of the servers. The second interface may be used to communicate a return-on-investment report to the user for refining a current or a future advertisement strategy, where such report is generated from information revealed in the trigger.

In one embodiment, the data associated with the purchase-related activity is generated based on the consumer selecting, from the web portal, one or more options for tracking at least one of historical consumer spending, consumer web portal usage, a consumer download, an executed transaction, and a shipping notice, where the shipping notice may be tracked by the application through web-based integration with a shipping company. In addition, the consumer may select settings on the web portal for storing consumer credit card and billing information, triggering an automatic purchase of the advertised product, generating automatic email notifications, maintaining updates for the application, and enforcing parental controls over at least one of the purchase-related activity, content download, and content viewing.

In one embodiment, the trigger stored in the data library of the application reveals an identity of the consumer. In addition, the trigger may be used to calculate a length of time from the consumer responding to the advertisement to the consumer purchasing the product. The trigger may also be used to provide a comparison of sales resulted from advertisements delivered to the consumer via the direct mailing address, the interactive television environment, and the web portal.

In one embodiment, a recommendation engine is provided for recommending at least one media campaign to the user based on searching the data library using a targeting goal, where the targeting goal is one of a consumer identity, a geographical profile, a demographic profile, and a sales profile. The application also includes a consumer access control feature that allows the consumer response data to be communicated to the web portal only after content associated with the advertisement is compared to at least one of a rating, a password, and pre-selected content. In addition, multiple passwords may be assigned to multiple web portal login accounts, where, upon a consumer logging into the web portal using one of the passwords, the consumer is able to control the other accounts. Moreover, in the event of the advertisement being assigned a wrong airing time or location, the application is adapted to perform at least one of preventing transmission of content between a television server and an automatic scheduling system and preventing a transmission of billing data to a subscriber of the application.

### BRIEF DESCRIPTION OF THE DRAWINGS

These and other features and advantages will be more fully understood by the following illustrative description with reference to the appended drawings, in which like elements are labeled with like reference designations, and in which the drawings may not be drawn to scale.

FIG. 1 illustrates one embodiment of an interactive multi-platform media environment of the present invention.

FIG. 2 illustrates a media advertising application used in the embodiment shown in FIG. 1.

FIG. 3 illustrates a communicational network for the embodiment shown in FIG. 2.

FIG. 4 illustrates a data library used in the embodiment of FIG. 2.

FIG. 5 illustrates a media-planning recommendation engine used in the embodiment of FIG. 2.

FIG. 6 illustrates a web portal used in the embodiment shown in FIG. 1.

FIG. 7 illustrates an exemplary hardware implementation.

### DETAILED DESCRIPTION OF ILLUSTRATIVE EMBODIMENTS

The invention, in various embodiments, provides, among other things, systems and methods for creating and enforcing accountability in interactive media advertising through active monitoring of media advertisement data associated with an array of media sources and across various platforms. The following detailed description of the invention refers to the accompanying drawings. The following detailed description does not limit the invention, and the various embodiments set out below and depicted in the figures are merely provided for the purposes of illustrating certain embodiments of these systems and methods and for describing examples of such systems and methods. However, it will be apparent to those of skill in the art that the systems and methods described herein may, in certain forms, be employed in cable, network and satellite radio programming and other applications. Thus, the scope of the invention is at least the scope defined by the appended claims and equivalents.

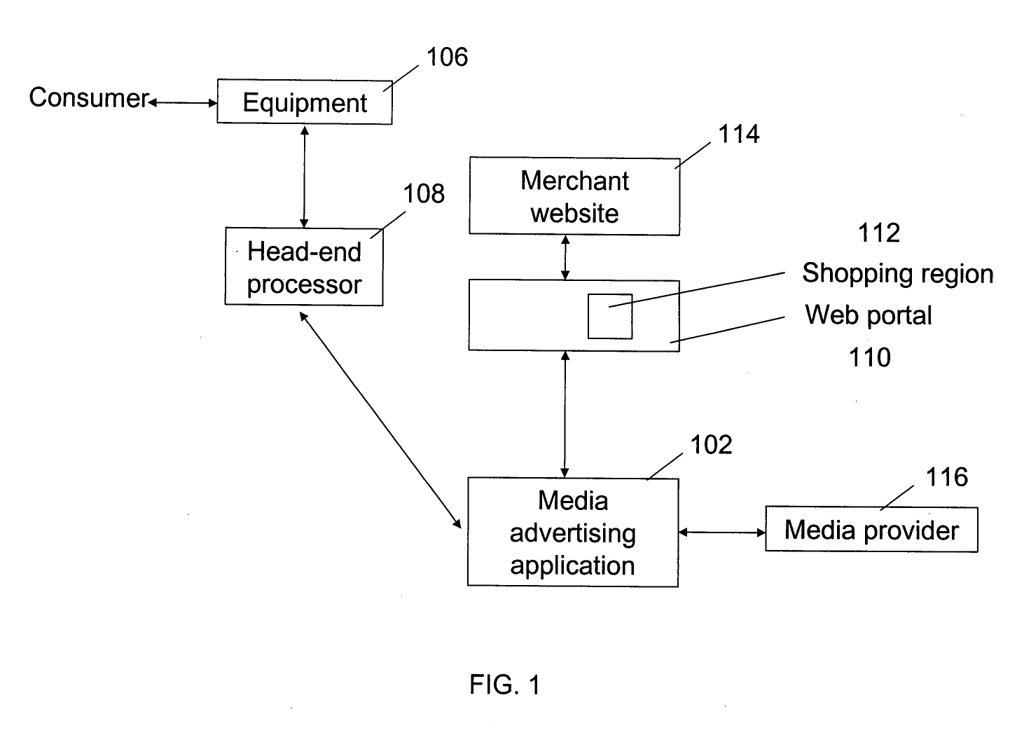

FIG. 1 provides an exemplary media advertising environment 100, according to an illustrative embodiment of the invention. Central to the media advertising environment 100 is a media advertising application 102 that communicates with an array of media sources to facilitate an exchange of information related to advertisement content. These media sources include, for example, advertisement providers, media providers, product retailers and consumers. A media provider may be a cable company, a telephone company (TELCO), a Regional Bell Operating company (RBOC), a digital broadcast station, an overbuilder, or a direct broadcast satellite company. In certain examples, information related to advertisement content is generated from a consumer responding to an interactive television advertisement. This response may be collected by a piece of equipment 106, such as a set-top box, connected to the consumer's television set, from which the response data is forwarded to a head-end processor 108 before being transmitted to the media advertising application 102 for data processing and analysis. The head-end processor 108 may be supplied by the media advertising application 102 or a media provider.

The media advertising application 102 subsequently communicates the processed consumer response data to a web portal 110 that allows the consumer to purchase the advertised product from a shopping region 112 of the web portal 110 or from a merchant website 114 accessible from the web portal 110. In certain examples, information related to advertisement content is generated from a consumer performing, via at least one of the shopping region 112 and the merchant website 114, purchase-related activities associated with the product. Exemplary purchase-related activities include data retrieval, data review, data cataloging, data deletion, purchase execution, in-store product reservation and media content download. In certain arrangements, the web portal 110 is owned by a media provider. In other arrangements, the web portal 110 is a part of the media advertising application 102, but may be hosted by a media delivery company. In addition, the merchant website 114 may be owned by a retailer whose advertisement tends to generate revenue for a media delivery company with whom the advertisement is placed. The merchant website 114 may also be pre-selected by a consumer to be linked to his or her web portal 110. Exemplary retailers include Fortune 1000 companies, small or medium-size companies, or online-shopping businesses offering goods or services that can be bought, sold, downloaded, or otherwise reserved through digital television. In certain examples, information related to advertisement content is exchanged between the media advertising application 102 and a provider 116 of the advertisement, such as an advertisement agency.

Aggregate data collected from the variety of media sources described above is stored in the media advertising application 102 and is used to produce return-on-investment (ROI) analysis for interactive advertisements delivered within the interactive advertising system 100. The resulting ROI analysis tends to reveal a measure of accountability or success for each advertisement based on correlations formed between consumer response and subsequent online purchases. In addition, subscribers of the application 102 are able to use the advertisement ROI analysis to perform at least one of media campaign optimization, consumer demographics selection, media outlet determination, media buying negotiation, predictive campaign planning, and ranking of media buyer and content effectiveness. Typically, subscribers of the application 102 are the same media sources from which the data related to advertisement content is collected in the first place to generate the ROI analysis. Thus, the media advertising application 102 is able to maintain a self-optimizing system that drives accountable sales across both television and the Internet based on a continuous circulation and refinement of data throughout the entire system.

In an exemplary implementation, data communication in the interactive advertising environment 100 of FIG. 1 is established through the usage of a trigger that captures consumer response data from both the interactive television environment and the Internet space. A trigger initially reaches a consumer as a part of video content of an interactive television advertisement. Upon the consumer responding to the advertisement, the trigger captures consumer demographics information, along with information related to the advertisement, and is forwarded to the media advertising application 102 via the set-top box 106 and the head-end processor 108. The advertising application 102 is adapted to further transmit the trigger to an appropriate web portal 110 or merchant website 114, wherefrom the advertised product may be purchased by the consumer. Hence, the trigger is adapted to contain sufficient information to enable its accurate sourcing to the correct web portal 110 or website 114. Inbound trigger information includes, for example, advertisement time of day, media outlet information, length of the advertisement, advertised product offer code, and any other digital information that may assist the trigger being transmitted to the correct retailer web site 114 or web portal 110. Once a trigger is received by the web portal 110, it is deposited into a link selectable by the consumer to initiate a download or purchase of the advertised product. In certain examples, the link resides in a retailer website 114 that is accessible from the web portal 110. In other examples, the link is in the default shopping region 112 of the web portal 110. Upon a consumer executing a purchase request by activating the link, the resulting trigger additionally captures sales information regarding the purchase, such as a price point, time of day, and location of the purchase. The executed trigger may also include information such as a tag number, a coupon code, and a description of the purchased product or service. For example, if the consumer downloads purchased music content from iTune, the resulting trigger may capture information that identifies an artist or creator of the music content as well as its price. Executed triggers are downloadable from the web portal 110 by the media advertising application 102 for consumer response analysis, wherefrom a measure of advertisement accountability or success is determined.

In addition, the trigger may be used by a host of the web portal 110 or a provider of media content to provision optimal bandwidth associated with content download through the web portal 110 or a retailer website 114. Downloadable products include, for example, video, music, or textual content. Furthermore, a host of the web portal 110 may charge a provider of the content additional fees depending on the size of the download or royalty payment generated from the download. In general, however, products for sale from a web portal 110 or a merchant website 114 are not limited to downloadable content. Products may be services or merchandise from a variety of categories such as grocery, clothing, pet food and children's toys.

In certain implementations, a trigger that circulates through the system is encrypted so as to prevent unauthorized individuals or companies from determining advertisement accountability using media placement information revealed in the trigger. Exemplary media placement information includes a specific time, day and origin of the advertisement. Hence, in a preferred implementation, a trigger is encrypted by the media advertising application 102, for example, after the trigger is transmitted from the head-end processor 108 and before it is forwarded to the web portal 110. More specifically, encryption is accomplished by removing an identity-revealing portion of the metadata associated with advertisement video content after the content is converted to a trigger for ingestion into the media advertising application 102. The identity-revealing portion tends to identify at least one of a time, day and origin of the advertisement content. In certain practices, association of consumer demographics data to online sales data is only made within the media advertising application 102. Therefore, when a consumer purchases a product from the web portal 110, the executed trigger is adapted to conceal its media placement information until the trigger is transported to the media advertising application 102 for processing. A key to decrypt the encrypted trigger is stored only within the media advertising application 102 and cannot be readily found on the Internet. The media advertising application 102 thus serves as a bridge between the consumers and the media providers for matching advertisement responses to information such as online sales figures, catalog sales orders, fulfillment data, telemarketing call results, and other electronic financial information related to the advertisement. If a subscriber of the application is behind on paying his or her subscription fee, the application 102 is able to prevent the subscriber from determining accountability for a particular advertisement that is of interest to the subscriber. The complete consumer response, advertisement and sales information is only revealed to the subscriber from a secured source, such as in a password-protected ROI analysis report, after the application 102 validates the subscriber's account and standing.

Various components of the interactive media advertising environment 100 of FIG. 1 are described below. In a preferred embodiment, the piece of equipment 106, which may be a set-top box, includes a program installed therein to detect the presence of an interactive television advertisement as well as the presence of a trigger embedded in the content of the advertisement. The set-top box 106 is also able to detect a response by a consumer to the advertisement. Such response may be generated by the consumer pressing a button, such as an “ok” button, on a remote control to select the advertisement. The set-top box 106 then transfers the trigger, including its data related to the consumer response, to a head-end processor 108 through an upstream link. Such transfer is performed either in real-time or with data stored in an internal memory of the set-top box 106. The head-end processor 108 subsequently forwards the trigger to the media advertising application 102 for storage, processing, and ROI analysis. In certain configurations, the set-top box 106 is able to directly transmit the trigger to the application 102 without using any intermediate data-forwarding devices.

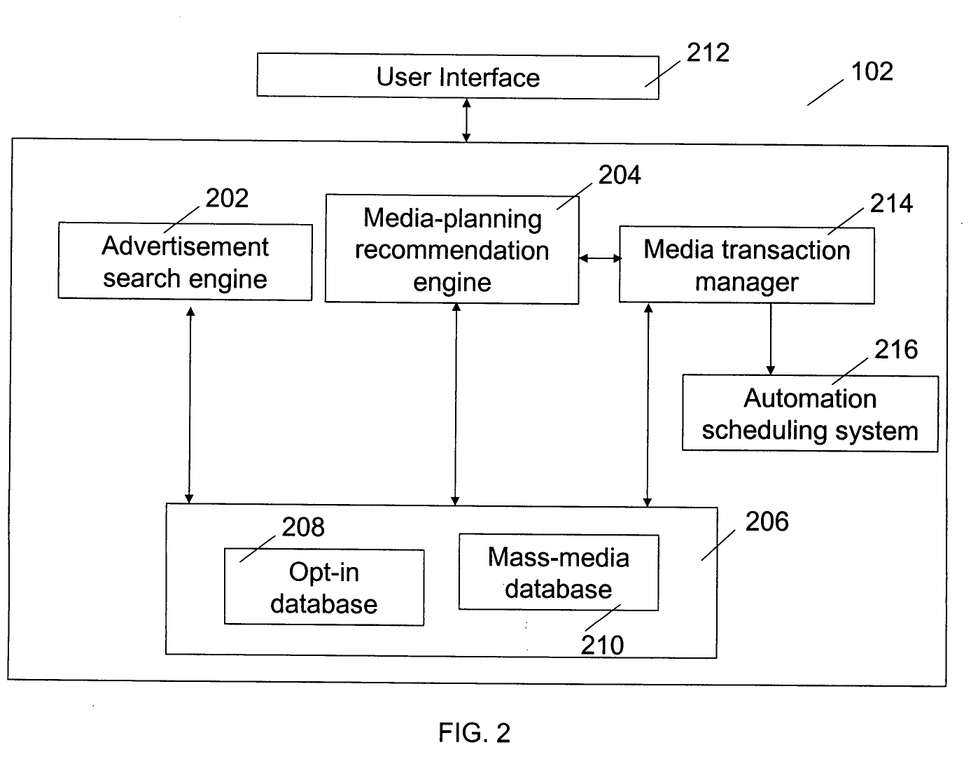

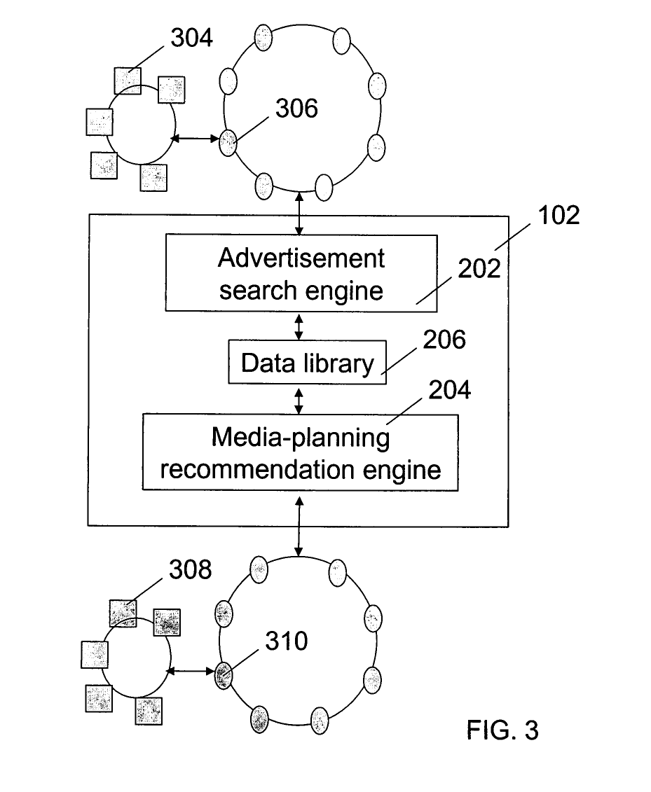

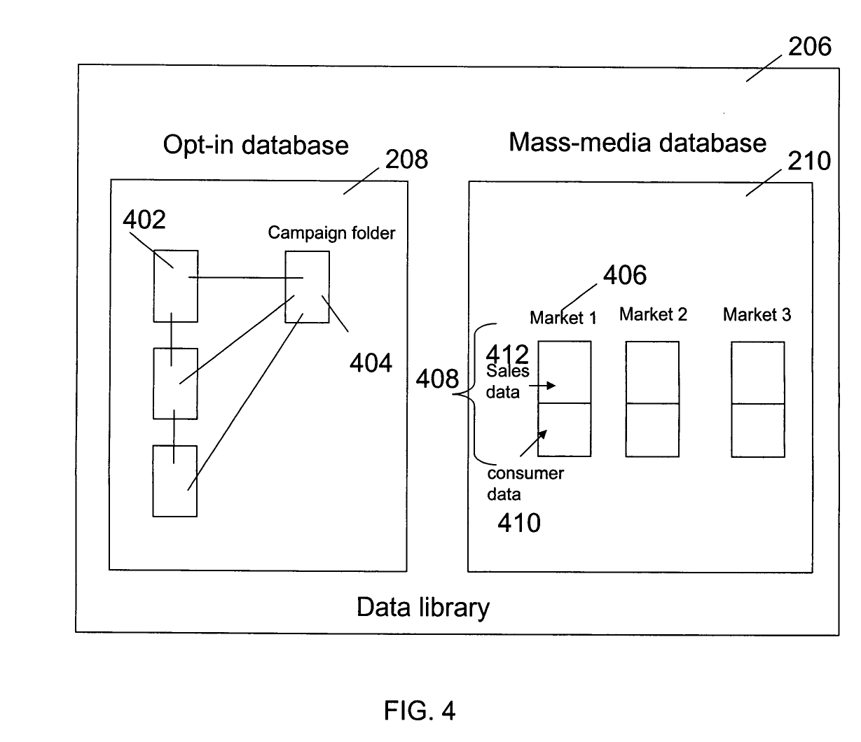

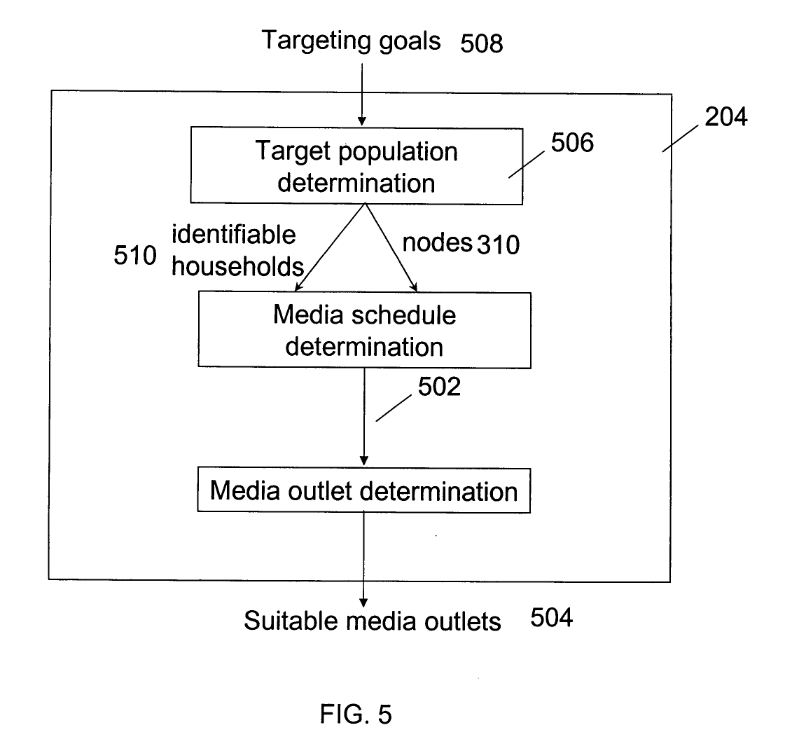

FIG. 2 shows an exemplary block diagram of the media advertising application 102 depicted in the interactive media advertising environment 100 of FIG. 1. In particular, an advertisement search engine 202 and a media-planning search engine 204 are connected to a data library 206 of the media advertising application 102. The data library 206 includes an opt-in database 208 and a mass-media database 210 for storing aggregate triggers pertaining to consumer viewing preferences and consumer purchase habits. Details regarding the data library 206 are described below with respect to FIG. 4. The advertisement search engine 202 of the media advertising application 102 provides a list of retailer websites 114 based on querying the data library 206 using one or more search terms supplied by a user of the search engine 202. The resulting retailer websites 114 are ranked according to certain criterion revealed in the triggers associated with each website 114. In addition, the advertisement search engine 202 provides links to the ranked websites 114 via connections from their respective servers, which are described below with respect to FIG. 3. The recommendation engine 204, also coupled to the data library 206, determines optimal media campaign schedules and suitable media outlets based on the generation of a target population list using one or more target goals input by a user of the search engine 206. In a consumer non-identifiable approach to advertising, the target population list may identify multiple nodes, which are described below with reference to FIG. 3, where each node links together a neighborhood of consumers whose identities are concealed from the user. In this case, consumer response analysis is done at a neighborhood, or node, level to provide the optimal media campaign schedule and the suitable media outlets. Alternatively, in a consumer-identifiable approach to advertising, the target population list may identify one or more consumers. Hence individualized responses to advertisements are analyzed to determine the appropriate media campaign schedule and the suitable media outlets. Details of the media-planning recommendation engine 204 are provided below with respect to FIG. 5.

In certain implementations, the media advertising application 102 also includes a user interface 212 that allows an authorized user to drill down into the application 102 to obtain customized ROI analysis data that tracks advertisement performance at any user-specifiable detail. In certain implementations, the application 102 includes a media transaction manger 214 that provides automated media buying and account management services to a user of the application 102. The media transaction manager 214 allows the user to transact media purchases, manage accounts related to media purchases, and track media delivery generated from media purchases. In certain examples, media purchases are made based on commercial schedules and outlets recommended by the media-planning recommendation engine 206. This media transaction manager 214 may be coupled to an automation scheduling system 216 of the application 102 to schedule an airing of purchased program content at a specific time and from specific media outlets, as agreed upon by terms of the purchase. Details regarding the automation scheduling system 216 are described below.

As shown in FIG. 3, a server 302 may be used to facilitate data communication between the media advertising application 102 and a media delivery company such as a retailer, a cable company, a media outlet, a direct mail company, an advertiser, a billboard company, a publishing company, a catalog company, or any company or individual that has permission to upload aggregate data to or download aggregate data from the application 102. In addition, a node structure 306 may be formed that links together multiple servers 304 so that more than one individual or company is able to access and share information with the application in accordance to a pre-determined permission level assigned to the node 306. Moreover, multiple nodes 306 may communicate with the application 102 according to multiple permission levels that are assigned to respective ones of the nodes 306. The permission levels may be set by the application 102, the media outlets, the consumers, or the cable companies in observance to certain privacy regulations. On the consumer side, a set-top box 308 may be used to communicate responses from a consumer to the application 102. One or more node structures 310 can also be formed on the consumer side, where each node 310 is adapted to link together a neighborhood of consumers by their set-top boxes 308 for communication with the application 102.

FIG. 4 shows an illustrative configuration of a data library 206 of the media advertising application 102 depicted in FIG. 2. The data library 206 is partitioned into two distinct databases consisting of an opt-in database 208 and a mass-media database 210. The opt-in database 208 houses aggregate triggers collected, for example, from various current or historical interactive advertisement campaigns. Each trigger is likely to include identity-revealing information pertaining to individual households or consumers from whom advertisement response data is collected as well as details regarding products the consumers have purchased. In particular, the trigger may be archived in a customer folder 402 of the opt-in database 208, as illustrated in FIG. 4. The trigger includes information such as a specific time of day of the advertisement to which the consumer responded, content of the advertisement, location of the consumer, one or more products advertised from the advertisement, advertised price point, product marketer information, consumer information and media outlet information. If the trigger subsequently results in an online product purchase by the consumer via the web portal 110 or the website 114, then purchase information related to the executed trigger is also housed in the customer folder 402. Exemplary purchase information includes a specific time of day the advertised product is purchased, website of the purchase, price point of the purchase, any repeat product purchase information, and time from contact to purchase. Purchase information may also include a location or a name of the catalog from which the purchase was made. In addition, a unique identification number may be assigned to a trigger for linking to a media campaign stored in a campaign folder 404. Details regarding the campaign folder 404 are described below.

In certain implementations, the households identified in the opt-in database 208 correlates to opt-in members of their respective media campaigns. The opt-in respondents are classified as those who requested a specific action regarding a product via, for example, a phone, a remote control or the web portal 110. Explicit opt-in requests may also be made through mailing list submissions or during product purchases. However, the respondents may select a ‘mass media only’ option with their responses so that these respondents cannot be identified for direct media targeting.

Advertisement data pertaining to specific media campaigns may also be organized into their individual folders 404 and archived in the opt-in database 208 of the data library 206. The advertisement data can be obtained by the application 102 through a server 304 connection to a provider of the advertisement 116, as depicted in FIG. 1. In particular, each campaign folder 404 is assigned a unique tag number for correlation to those customer folders that contain triggers associated with the media campaign. Each tag number is automatically generated and assigned to an advertisement at the moment of the advertisement's inception and may be transmitted to the media advertising application 102 based on the user responding to the advertisement from an interactive environment. An exemplary campaign folder 404 includes, for example, a campaign script, a telemarketing script, a campaign creative, a package insert, a campaign budget, or a link to a third-party media-service provider. A campaign folder 404 may further include advertisement rates and/or sales information regarding the media campaign.

FIG. 4 provides an exemplary configuration of the mass-media database 210 of the data library 206 as shown in FIG.2. The mass-media database 210 of the data library 206 contains trigger and media campaign information that is accessible by any subscriber of the media advertising application 102. Trigger information in this mass-media database 210 is sufficiently high-level that identities of individual household respondents and their specific product purchase information are concealed from those accessing the database 210. It is likely that those respondents have not given their opt-in approval to the media campaigns at the time of data collection; hence their privacies are protected through this non-identifiable approach to information sharing. High-level trigger information 408 may include consumer data 410 such as a consumer geographical profile or a demographic profile, and may be classified under a corresponding broad product market category 406. Likewise, campaign data 412 stored in the mass-media database is sufficiently high-level that product-specific information is removed from the data to provide anonymity to the providers of the media campaign. Campaign data 412 may include information such as an advertisement rate profile or a sales profile, and may also be classified under a corresponding product market category 406. In addition, consumer data 410 may be linked to a category such as “fitness” that tracks past fitness of specific product consumption patterns without revealing the identities of the associated clients or media outlets. In certain examples, the mass-media portion 210 of the data library 206 can be shared with a group of subscribers, where overall aggregated sales and response results, identifiable down to a node level 310, as depicted in FIG. 3, are used to assist the users in their advertisement planning.

With reference to FIG. 2, an illustrative configuration of an advertisement search engine 202 of the media advertising application is provided. In particular, the advertisement search engine 202, coupled to the data library 206, provides a ranked list of merchant websites 114 and/or web portals 110 determined based on a query of the data library 206 using one or more search terms. In general, the web portals 110 and websites 114 are ranked according to certain criterion revealed in the triggers that are executed from the respective interfaces. More specifically, in certain examples, a retailer website 114 tends to be ranked higher by the search engine 202 if the website 114 generates a higher volume of clickstream data, as determined by its executed triggers stored in the data library 206 of the media advertising application 102. In certain examples, a website 114 is ranked higher by the search engine 202 if the website 114 has a higher aggregate sales figure, as revealed in its executed triggers. Consequently, website rankings are used to inform media buys, influence retailers' business strategies, and affect future click-through rates within the Internet space. The search engine 202 operates by giving more weight to companies that have both television and web presences since these companies are more established and have trustworthy reputation in their industries. The search engine 202 thus provides a safe and reliable on-line shopping experience to consumers and, at the same time, rewards those companies that advertise using the media advertising application 102. Searches conducted via the advertisement search engine 202 may be by keywords, company names, advertiser URLs', and/or product categories.

FIG. 5 shows an illustrative configuration of a media-planning recommendation engine 204 of the media advertising application 102 as depicted in FIG. 2. In particular, the media-planning recommendation engine 204, coupled to the data library 206, determines an optimal media campaign schedule 502, a list of suitable media outlets 504, and a target population list 506 by querying the data library 206 using a set of targeting goals 508 input by a subscriber of the application 102. The targeting goals 508 specify those desired characteristics the subscriber wants to have in his or her consumers so as to maximize advertisement ROI. In certain examples, the targeting goals 508 are mass-media goals that do not identify any particular households, but instead, direct the media campaign to one or more neighborhood nodes 310 based on criteria such as geographical regions, demographic profiles, and/or historical product responses. In other examples, the targeting goals 508 consist of a direct-mailing list that may be used to identify one or more households 510 to whom the media campaign should be served. The identities of the households may be explicitly provided by the targeting goal based on a search of the opt-in portion 208 of the data library 106. The recommendation engine 204 proceeds to use this target population list 506, along with addition subscriber inputs regarding the desired media campaign itself, to determine the optimal campaign schedule 502 from which suitable media outlets 504 offering such campaign schedule are found and recommended to the subscriber.

In certain implementations, customized ROI analysis reports may be provided to a user of the media advertising application 102 via an interface 212 of the application 102, such as the interface shown in FIG. 2. The user is like to represent, for example, a cable company, a media outlet, a direct mail company, an advertiser, a billboard company, a publishing company, a catalog company, and a retailer. Each ROI analysis report is adapted to include drill-down data related to one or more current or historical advertisements that are of interest to the user. An exemplary ROI report includes information such as a percentage of executed purchases associated with an advertisement budget, a product category, a time of purchase, purchased content and a media outlet. A price point of the most effective advertisements determined by the application 102 may also be provided to the subscriber from a ROI report. Other ROI information includes, for example, a length of time from advertisement airing to purchase order execution or to product shipping, drag effect that involves average time to purchase execution, sales information by identifiable household or demographic attributes, and opt-in or opt-out requests by consumers for television-based, direct mail based, and internet-based advertisements. In addition, a ROI report may include a comparison of sales generated from advertisements via direct mailing, the Internet space, and interactive television environment. The resulting ROI information may be used by a subscriber to influence a current or future target advertising strategy implemented through the media advertising application 102. For example, in a consumer-identifiable approach to advertising, the application 102 allows the subscriber to target a consumer with specific commercials, coupons and/or promotional deals for products or services that are complimentary to products or services purchased by the consumer. In one example, a cable company or an advertiser chooses to award bonus points to a consumer when the consumer attains a certain response or purchase level. In a consumer non-identifiable approach to advertising, a subscriber of the application is allowed to refine direct mailing delivery dates, website designs, interactive television advertisements, or a combination thereof to promote accountability in sales by regions, income levels, and other demographic profiles. Such high-level profiles are determined by the subscriber based on, for example, searches conducted from the media-planning recommendation engine 204 using one or more targeting goals 508. In another example, the application 102 offers a global coupon or discount to all consumers via their respective web portals 110 so as to promote consumer loyalty to the application as well as to the providers of the web portals 110.

In certain implementations, the media advertising application 102 is able to coordinate the airing of advertisement content purchased through the application 102 using an automation scheduling system, such as the automation scheduling system 216 shown in FIG. 2. This scheduling system 216 is adapted to insert commercial content into regular programming at a specific time and on a specific network, as specified by terms of the purchase. Exemplary networks include television, cable and satellite. Commercial airing Instructions may be given to the automation scheduling system 216 by a media transaction manger 214 of the application 102 that handled the transaction aspect of the media purchase. The media transaction manger 214 is also able to track the subsequent media delivery via the scheduling system 216. More specifically, checks may be performed at predetermined times prior to the scheduled program air time to determine if the particular commercial is properly queued in a network server. Checks may also be performed by comparing an “as-aired” verification to an “as-scheduled” verification for the purchased program content. If a wrong schedule or wrong delivery location is assigned to a specific commercial, the application 102 may promptly prevent transmission of media content from the automation scheduling system 216 to the network server to prevent program airing. The application 102 is also able to prevent bills being served by the media transaction manager 214 to the parties associated with the erroneous transaction.

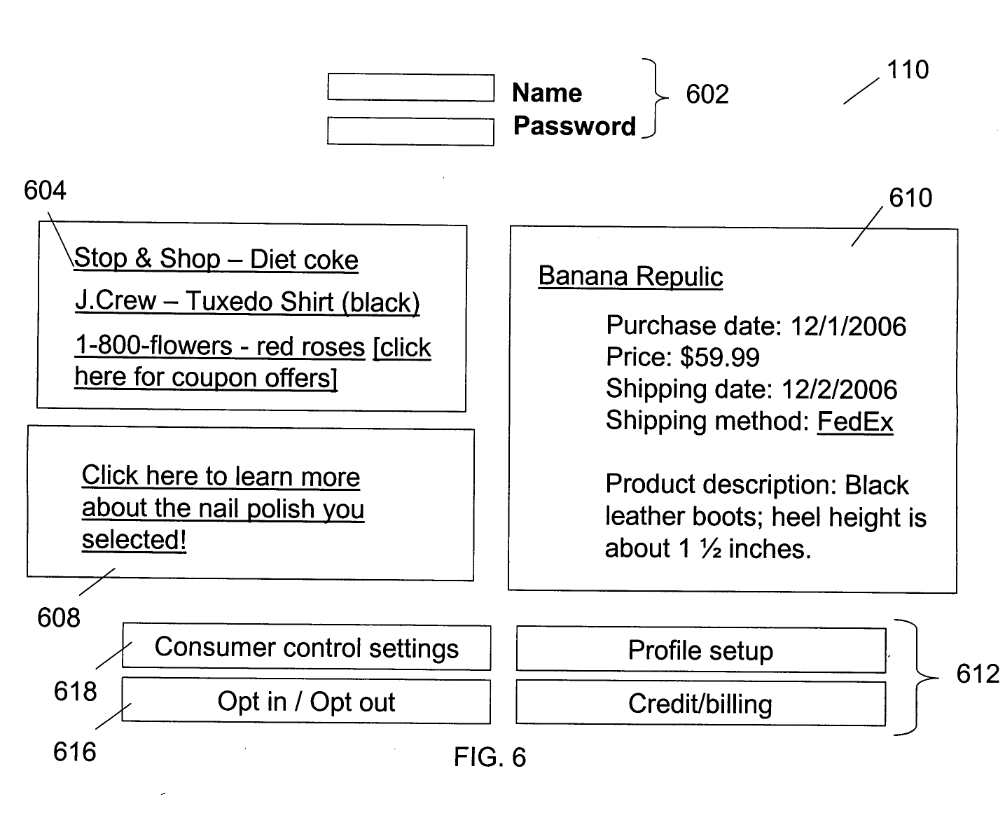

FIG. 6 shows an illustrative configuration of the web portal 110 depicted in the interactive media advertising environment of FIG. 1. Such web portal 110 may be a part of the media advertising application 102, but may be hosted by a media provider such as a cable company, a TELCO, a RBOC, a digital broadcast station, an overbuilder, or a direct broadcast satellite company. As depicted, a login area 602 is provided on the web portal 110 for allowing a consumer to enter his or her account information in order to gain access to products offered by various retailers. In one embodiment, the web portal 110 presents to the consumer hyperlinks 604 to merchant websites 114 for purchasing products selected by the consumer from one or more interactive advertisements. The consumer's account with the web portal 110 allows the consumer to gain direct access to the merchant websites 114 without requiring separate accounts or passwords. Master account information for a consumer may be saved to the media advertising application 102 or to the web portal 110 in order to facilitate the consumer's online shopping experience. In certain instances, one or more merchant websites 114 are loaded into the web portal 110 upon the consumer logging into the web portal 110, where such loading is executed based on, for instance, a promotional agreement that exists between the retailers and the media provider or the media advertising application 102. In addition, merchant websites 114 shown on the web portal 110 may be arranged by the consumer according to, for example, product categories or product names. In another embodiment, product information is presented from a shopping region 608 of the web portal 110. This shopping region 608 is established to promote businesses that may not have a strong web presence. In this case, the consumer is able to obtain more information about the products shown on the shopping region 608 or even purchase the product from the shopping region 608 based on, for example, prior agreements between the product retailers and the web portal 110 or the media advertising application 102. In general, products viewable in the consumer's web portal 110 may be selected by the consumer from advertisements in interactive television environment as well as from other interactive media platforms. Hence the consumer is able to perform, via a unified web portal 110, purchase-related activities with respect to click-through responses generated from a variety of interactive media sources.

In certain implementations, triggers related to certain transactions are presented to the consumer for review from the web portal 110. Each trigger typically includes products sales information generated from a “click-through” consumer response to an interactive advertisement. In particular, executed trigger data presented to a consumer may be a date on which the consumer responded to an advertisement, a date of execution of the subsequent purchase, a price point of the product purchased, shipping information of the purchased product, and a description of goods or services. In certain implementations, executed triggers are presented to the consumer from a dashboard 610 of the web portal 110 upon the consumer logging into the web portal 110. The consumer is able to sort, filter and rank current and historical executed triggers according to a selectable criterion such as a date of purchase or a product name.

In certain implementations, the web portal 110 includes a variety of settings 612 that let the consumer customize his or her web portal environment. For example, some of the settings 612 are selectable by the consumer to execute automatic transactions upon a confirmation of product availability. Some of the settings 612 allow the consumer to specify automatic email delivery notifying him or her triggers for executed transactions or pending transactions or to track total historical spending across the entire web portal 110. Some settings 612 allow the consumer to enforce parental control over certain portions of the web portal 110 or retailer websites 114 such that a minor is guarded from making unauthorized purchases or downloading illegal content from the web. Parental control over advertisement content will be described below in more detail. In addition, certain settings 612 permit the web portal 110 to set up different profiles for different members of the consumer household in order to provide individualized shopping experience to each of the household members. Certain settings 612 are selectable by the consumer to save his or her information, such as a mailing address, to the system so that this information may be used to perform future targeted advertising, such as sending advertisements of potential interest to the consumer via his or her web portal, television set, or mailing address. Details regarding this opt-in approach to advertising will be described below. Settings 612 of the web portal 110 also permit the consumer to track product shipping notices through web-based integration 614 with shipping companies such as FedEx and UPS. Moreover, certain settings 612 of the web portal 610 are selectable by the consumer to schedule system maintenance updates, create a wallet for storing credit card and billing information, and opt into or opt out of selected advertisements. In some examples, settings 612 chosen by the consumer are transferable to another web portal 110 if the consumer moves to a different city or state.

In one embodiment of an opt-in setting 616 of the web portal 110, a consumer is able to opt into advertisements offered by certain product lines or companies from his or her online web portal account. These advertisements may be interactive television advertisements, internet advertisements, or direct mailing advertisements, in which case the consumer is likely to provide a mailing address to receive such advertisements. In addition, the consumer is able to specify a general product category he or she wants to receive advertisements from. The consumer is also able to change his or her selection for specific product or company advertisements from either the web portal 110 or the individual retailer websites 114. Moreover, the consumer is able to de-select commercials offered by a product line or a product company. Hence, consumer choices are preserved and promoted which results in increased overall advertising efficiency in the form of optimized advertising campaigns and bandwidth savings. For those consumers who are opting into an online or direct mail advertisement due to a lack of television advertisement options, the media advertising application 102 is configured to recognize such condition and is adapted to notify those service providers closest to the consumer in order to remedy the situation. This functionality allows the application 102 to build its opt-in database 208 while providing value to cable and satellite providers. For those consumers who choose not to opt into an advertisement or having just opted out of an advertisement, the consumers are still able to be targeted with advertisements, but based on demographics information obtained at a mass-media node level 310 instead of at an individual consumer level. Hence, the advertisers are adapted to gain advertising efficiency through blended media campaigns and judicious allocation of spending dollars that target interested consumers as opposed to passive viewers.

In one embodiment of a consumer control setting 618 described above, a consumer is able to enact security features to prevent another consumer from accessing certain media content within television and Internet environment. For example, parents are allowed to control what children view through the web portal 110 by setting security levels or blocking certain questionable websites. In addition, adults are able to choose one or more settings of the web portal to pre-select commercials that are displayable to children. More specifically, parents are able to monitor children's interactions with certain television advertisements through the usage of a V-chip that blocks the display of television programming based upon its rating. Hence, parents are able to make use of a V-chip to block inappropriate interactive television commercials broadcast on adult programs and other premium cable and satellite channels. This may be accomplished by assigning different passwords for accessing a set-top box to different members of the household in order to distinguish the household members. This may also be accomplished by assigning and registering different set-top boxes 106 to different members of the household. Consequently, each member is provided with his or her own password to access his or her own web portal 110. If a member of the household is a child, then the child's parents, who have a master login account, is able to “child-proof the child's web portal 110 by, for example, blocking inappropriate product selections from entering their child's web portal 110 or pre-approving websites for their child to gain access to and receive promotions from. Content selection by the parents may be based on FCC television content ratings, third-party education rankings, or rankings provided by the advertisement search engine 202 of the media advertising application 102. Moreover, in certain implementations, the media advertising application 102 is able to install additional password controls over shows with adult content in the event that the child is able to bypass the V-chip protection. For example, a password may be prompted if commercial content having a higher than recommended FCC rating is selected by the viewer for uploading to the web portal 110.

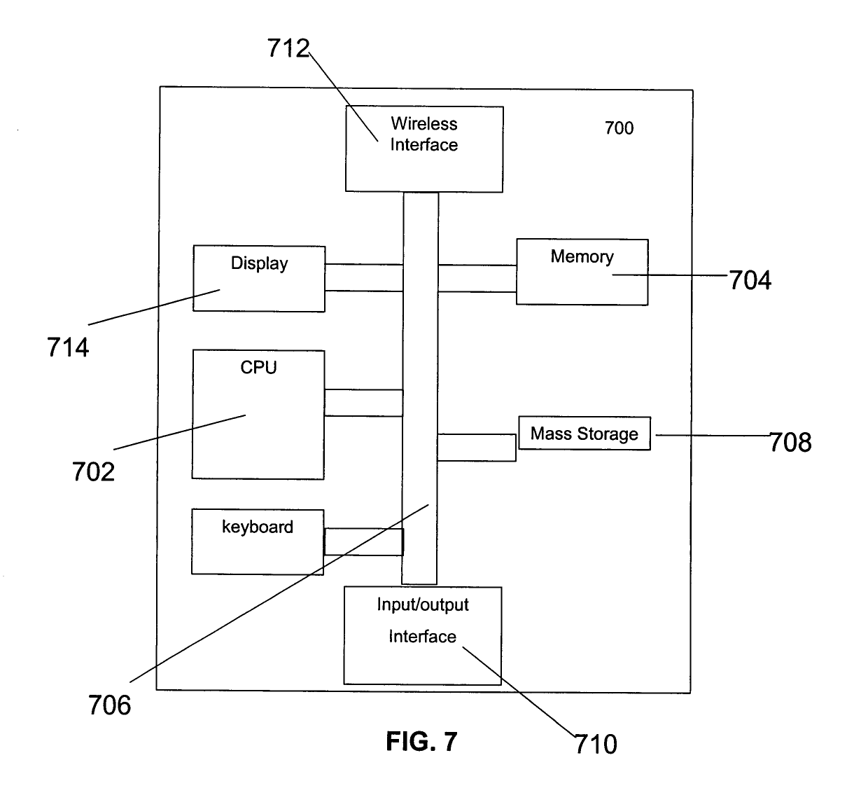

FIG. 7 shows a functional block diagram 700 of a general purpose computer system for performing the functions of the media advertising application and the web portals, according to an illustrative embodiment of the invention. The exemplary computer system includes a central processing unit (CPU) 702, a memory 704, and an interconnect bus 706. The CPU 702 may include a single microprocessor or a plurality of microprocessors for configuring the computer system as a multi-processor system. The memory 704 illustratively includes a main memory and a read-only memory. The computer 700 also includes the mass storage 708 device having, for example, various disk drives, tape drives, etc. The main memory also includes dynamic random access memory (DRAM) and high-speed cache memory. In operation, the main memory 704 stores at least portions of instructions and data for execution by the CPU 702.

The mass storage 708 may include one or more magnetic disk or tape drives or optical disk drives, for storing data and instructions for use by the CPU. At least one component of the mass storage system 708, preferably in the form of a disk drive or tape drive, stores the databases used for processing the functions of the media advertising application of the invention. The mass storage system 706 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 700. The mass storage 708 may support a database, such as opt-database 208 or mass-media database 210, as depicted in FIG. 2. The database can be any suitable database system, including the commercially available Microsoft Access database, or the Oracle database system and can be a local or distributed database system. The design and development of suitable database systems are described in McGovern et al., A Guide To Sybase and SQL Server, Addison-Wesley (1993). The database can be supported by any suitable persistent data memory, such as a hard disk drive, RAID system, tape drive system, floppy diskette, or any other suitable system, and connect to the system over a network or bus as shown in FIG. 7.

The computer system 700 may also include one or more input/output interfaces 710 for communications via a network of the computer system. The input/output interface 710 may be a modem, an Ethernet card or any other suitable data communications device. The input/output interface 710 may provide a relatively high-speed link to the network, such as an intranet, internet, or the Internet, either directly or through an another external interface. The communication link to the network may be, for example, optical, wired, or wireless 712 (e.g., via satellite or cellular network). Alternatively, the computer system may include a mainframe or other type of host computer system capable of Web-based communications via the network.

The computer system also includes suitable input/output ports or use the interconnect bus for interconnection with a local display 714 and keyboard or the like serving as a local user interface for programming and/or data retrieval purposes. Alternatively, server operations personnel may interact with the system for controlling and/or programming the system from remote terminal devices via the network.

The computer system may run a variety of application programs and stores associated data in a database of mass storage system 708. One or more such applications may enable the receipt and delivery of messages to enable operation as a server, for implementing server functions relating to the media advertising application 100 of the present invention. The components contained in the computer system 700 are those typically found in general purpose computer systems used as servers, workstations, personal computers, network terminals, and the like. In fact, these components are intended to represent a broad category of such computer components that are well known in the art. Certain aspects of the invention may relate to the software elements, such as the executable code and database for the server functions of the media advertising application.

It will be apparent to those of ordinary skill in the art that methods involved in the present invention may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, having a computer readable program code stored thereon.

Exemplary usage of the media advertising application 102 of the present invention is provided in the following examples. In one example, children are able to watch educational shows, such as Sesame Street, and click on different segments of the show. When the children visit their web portals 102, they are able to see downloaded multi-media lessons related to the segments of the show. Such automatic download of program content may be pre-selected or pre-approved by patents. Subsequently, parents are able to gain increased control of and value from their child's television viewing experience.

In another example, digital elements of a “Cherry Coca-Cola” advertisement is first distributed from an automation scheduling system 216 of the media advertising application 102 to pertinent broadcast television stations or cable systems. Subsequently, a consumer viewing the Cherry Coca-Cola advertisement clicks an “OK” button on his or her remote control to select the advertisement. A set-top box 106 captures the click and uploads a link to an online grocery store for Cherry Coke from the consumer's web portal 110, along with a unique tag identifying the exact commercial airing. The specific grocery store may be a sponsor of the advertisement or may be pre-selected by the consumer as his or her grocery store of choice. In certain instances, the consumer orders, via the web portal 110, groceries to be delivered to his or her home. In certain instances, the consumer swipes his or her frequent purchase card in the grocery store to retrieve the Cherry Coke. Hence, success rate associated with a Cherry Coke advertisement can be calculated by the media advertising application 102 using data captured from the consumer responding to the advertisement and the consumer purchasing the advertised product.

In an example of the opt-in feature of the web portal, if a consumer places an order with a car dealership, via his or her web portal 110, expressing interest for leasing a Mercedes Benz, that consumer may choose to opt out of all future interactive commercials corresponding to automobile leasing or purchasing. Likewise, the same “Mercedes Benz” consumer may opt to receive commercials related to high-end automobile accessories. This creates system-wide advertising efficiencies that promote optimized advertising campaigns and bandwidth savings for cable companies and, at the same time, ensure a safe and friendly shopping experience for consumers. These savings are passed back to the advertising agencies in the form of reduced commercial avail costs and improved media campaign creative which results in enhanced viewing experience for consumers.

In an example of the media advertising search engine 202, if a company is ranked relatively high by the search engine 202, then advertisements placed on the company's website 114 are likely to be charged more money per click than the same advertisements placed on a lesser-ranked website 114. This is because advertisements with the higher-ranked company are more relevant due to the reliability and popularity associated with the company's website 114.

The foregoing description of the preferred embodiment of the invention has been presented for the purposes of illustration and description. It is not intended to be exhaustive or to limit the invention to the precise form disclosed. Many modifications and variations are possible in light of the teaching herein.

What is claimed is:

1. A system for allowing a consumer to track an advertisement for a product, comprising:
an equipment for capturing a response by the consumer to the advertisement delivered from a first platform;
a portal, provided from a second platform, for allowing the consumer to execute a purchase-related activity associated with the product of the advertisement;
an analysis application for storing and managing a trigger that correlates data associated with the consumer response to data associated with the purchase-related activity; and
a server for displaying a plurality of triggers that allow the consumer to at least track the advertisement selected by the consumer from the first platform.

2. The system of claim 1, wherein the first and the second platforms include at least one of a television, an electronic display, and a website.

3. The system of claim 1, further comprising a website accessible from the portal, wherein the purchase-related activity associated with the product is performed via one of the portal and the website.

4. The system of claim 1, further comprising a head-end processor in communication with the equipment to receive the data associated with the consumer response and forward the data to the analysis application, wherein the equipment is a set-top box.

5. The system of claim 3, wherein the purchase-related activity includes the consumer performing one of data retrieval, data review, data cataloging, data deletion, purchase execution, and media content download from at least one of the portal and the website.

6. The system of claim 3, wherein the analysis application communicates to at least one of the consumer, a retailer and a media provider via at least one of the equipment, the portal and the website to determine at least one of the data associated with the consumer response and the data associated with the purchase-related activity.

7. The system of claim 6, wherein the media provider is one of a cable company, a telephone company, a Regional Bell Operating company, a digital broadcast station, an over-builder, and a direct broadcast satellite company.

8. The system of claim 1, wherein the trigger is embedded in content of the advertisement delivered to the consumer, and
upon the consumer responding to the advertisement, the trigger captures the data associated with the consumer response and is forwarded, via the analysis application, to the portal for incorporation into a link on the portal.

9. The system of claim 8, wherein upon the consumer executing a purchase order via an activation of the link, the trigger is adapted to capture data generated from the executed purchase order.

10. The system of claim 9, wherein the trigger, including the data associated with the consumer response and the data generated from the executed purchase order, is transmitted to the analysis application for determining a measure of success of the advertisement.

11. The system of claim 9, wherein the purchase order includes a download of at least one of music, video and textual content.

12. The system of claim 9, wherein the data related to the consumer response is adapted to reveal at least one of time of the consumer response, origin of the consumer response, and demographic information of the consumer.

13. The system of claim 9, wherein the data generated from the executed purchase order is adapted to reveal at least one of time, price point and location of the purchase order.

14. The system of claim 3, wherein the analysis application uses the trigger to track at least one of a download of online content from the website and a bandwidth associated with the download for performing at least one of provisioning a bandwidth associated with a future download and charging a fee for the future download.

15. The system of claim 1, wherein the trigger is encrypted by the analysis application to conceal at least one of time of the consumer response, origin of the consumer response, and demographic information of the consumer.

16. The system of claim 15, wherein the encrypted trigger is decrypted inside of the analysis application for allowing at least one of the time of the consumer response, the origin of the consumer response, and the demographic information of the consumer to be matched to the data associated with the purchase-related activity.

17. The system of claim 1, wherein the trigger is accessible by at least one of a media provider, a retailer, and an advertiser from the analysis application for refining a strategy associated with advertising in a media advertising space.

18. The system of claim 17, wherein the media advertising space includes one of television space, Internet space, billboard space, publishing space, and direct mailing space.

19. The system of claim 3, wherein the analysis application includes a search engine that is adapted to provide a plurality of websites based on a search term supplied to the search engine, wherein
the plurality of websites are ranked according to information revealed by a plurality of triggers corresponding to purchase orders executed from the respective websites.

20. The system of claim 3, wherein a retailer performs at least one of offering a discount incentive, sending a reminder, and presenting a targeted advertisement to the consumer for a product related to the product from the advertisement via at least one of the first platform, the second platform, the website, the portal, and a direct mailing address of the consumer.

21. The system of claim 3, wherein the portal assigns to the consumer at least one of an account and a password for secured access to at least one of the portal and the website.

22. The system of claim 3, wherein the consumer chooses, from at least one of the website and the portal, to receive a second advertisement.

23. The system of claim 22, wherein a decision of the consumer to opt into the second advertisement is captured by the trigger and communicated to the analysis application from at least one of the website and the portal.

24. The system of claim 22, wherein the consumer is adapted to opt out of the second advertisement from at least one of the website and the portal.

25. The system of claim 22, wherein at least one of a frequency and a type associated with the second advertisement is adjustable by the consumer.

26. The system of claim 1, wherein the data associated with the consumer response is communicated to the portal after content of the advertisement is compared to at least one of a rating, a password, and pre-selected content.

27. The system of claim 1, wherein at least one of the plurality of triggers allows the consumer to track a historical advertisement selected by the consumer from the first platform.

28. The system of claim 1, wherein the server displays the plurality of triggers from the portal.
